(19) United States
(12) Patent Application Publication
(10) Pub. No.: US 2024/0394514 A1
(43) Pub. Date: Nov. 28, 2024

(54) MACHINE LEARNING FOR OPERATING A MOVABLE DEVICE

(71) Applicant: Ford Global Technologies, LLC, Dearborn, MI (US)

(72) Inventors: Mazin Hnewa, East Lansing, MI (US); Alireza Rahimpour, Palo Alto, CA (US); Devesh Upadhyay, Canton, MI (US); Justin Miller, Berkley, MI (US)

(73) Assignee: Ford Global Technologies, LLC, Dearborn, MI (US)

(21) Appl. No.: 18/322,898

(22) Filed: May 24, 2023

(51) Int. Cl. G06N 3/0464; G06N 3/084

(52) U.S. Cl. CPC G06N 3/0464; G06N 3/084

(57) ABSTRACT

A computer that includes a processor and a memory, the memory including instructions executable by the processor to receive an image in a first neural network that outputs a first prediction based on the image, wherein weights applied to layers in the first neural network are determined by minimizing a sum of a first loss function and a second loss function. The first loss function can be determined from the first features determined in the first neural network trained to output a first prediction and from second features determined in a second neural network trained to output a second prediction. The second loss function can be determined based on comparing the first prediction to ground truth. The first prediction can be output.

### BACKGROUND

Computers can operate systems and/or devices including vehicles, robots, drones, and/or object tracking systems. Data including images can be acquired by sensors and processed using a computer to determine a location of a system with respect to objects in an environment around the system. The computer can use the location data to determine trajectories for moving a system in the environment. The computer can then determine control data to transmit to system components to control system components to move the system according to the determined trajectories.

### BRIEF DESCRIPTION OF THE DRAWINGS

FIG. 1 is a block diagram of an example vehicle system.

FIG. 2 is a diagram of an example image of a scene.

FIG. 3 is a diagram of an example image of a scene including objects.

FIG. 4 is a diagram of example teacher/student neural network training.

FIG. 5 is a diagram of example teacher/student neural network training.

FIG. 6 is a flowchart diagram of example teacher/student neural network training.

FIG. 7 is a flowchart diagram of an example process to operate a vehicle based on a teacher/student trained neural network.

### DETAILED DESCRIPTION

Systems including vehicles, robots, drones, etc., can be operated by acquiring sensor data regarding objects in an environment around the system and processing the sensor data to determine a path upon which to operate the system or portions of the system. The sensor data can be processed to determine a location of one or more objects, e.g., in real world coordinates. The determined real world locations can then be used to operate the system. For example, a robot can determine the location of a workpiece on a conveyer belt. The determined workpiece location can be used by the robot to determine a path upon which to operate to move portions of the robot to grasp the workpiece. A vehicle can determine a location of an object such as a pedestrian or other vehicle on a roadway. The vehicle can use the determined location to operate the vehicle from a current location to a planned location while maintaining a predetermined distance from the object.

Deep neural networks can be used for determining locations of objects in an environment around a system. Sensor data can be acquired from sensors included in a system and communicated to a computer that can execute instructions which include a trained deep neural network. The deep neural network receives the sensor data and outputs a prediction that can include detecting an object included in the sensor data. Object detection, in the context of this application, means to identify or label an object and determine its location according to a specified coordinate system typically according to real world coordinates. A vehicle operating on a roadway will be used herein as a non-limiting example of a system that acquires sensor data and processes it with a deep neural network to detect objects.

The ability of a deep neural network system to detect objects in sensor data can be based on training. In training a deep neural network, a training dataset that includes examples of various objects at various locations in various lighting and weather conditions can be used. The training dataset can include thousands of example images, each of which includes ground truth data that indicates the identities and real world locations of the objects included in the image. The deep neural network can be executed on the dataset of training images multiple times, where each time the deep neural network is executed the output prediction is compared to the ground truth to determine a loss function. The loss function can be backpropagated through the deep neural network from output layers to input layers to adjust weights which govern processing for each layer to minimize the loss function. When the loss function reaches a user-determined minimum for the training dataset, the deep neural network training can be deemed complete, and the weights indicated by the minimum loss function may then be stored with the trained deep neural network.

Once the trained deep neural network is deployed in systems in the real world, the performance of the deep neural network can depend upon how well the sensor data acquired by the system duplicates sensor data included in the training dataset. To be able to process sensor data to detect objects, the objects should be clearly visible in the acquired sensor data. The presence of nonideal imaging conditions can prevent a deep neural network from correctly detecting objects despite a training dataset that includes thousands or millions of images. Nonideal imaging conditions are conditions that can make obtaining useful image data difficult and may include low light conditions such as nighttime or overcast evenings and obscuring atmospheric conditions such as rain, snow, or fog. Nonideal imaging conditions cause low contrast pixel values between objects and backgrounds, which can make object detection difficult for machine learning techniques.

A technique for overcoming nonideal imaging conditions is to add one or more different types of image sensors to supply data to the training dataset and be used on the deployed system. For example, in addition to color video cameras, thermal infrared (IR) or gated IR sensors can be used. Thermal IR sensors generate image data by acquiring thermal photons in a wavelength range from about 1,000 nanometers (nm) to about 14,000 nm. Thermal IR sensors can require special lenses and cooled sensors to acquire thermal photons. An advantage of thermal IR sensors is that they detect heat emitted from human skin and can image pedestrians in low-light or night through obscuring atmospheric conditions. Gated IR sensors emit pulsed IR energy into the environment and then “gate” sensor acquisition. Gating a sensor means activating a sensor to acquire IR energy reflected by objects in a scene only during a brief time window. In this fashion only objects that reflect IR pulses at a distance determined by the time window are imaged by the sensor. Gating pulsed IR energy can reduce image clutter caused by nonideal atmospheric conditions and overcome low-light conditions.

Adding one or more of thermal IR and gated IR sensor data to a deep neural network system can enhance performance of a deep neural network system in low-light or nonideal atmospheric conditions; however, system complexity and required computing resources may consequently increase. For example, adding an additional sensor type can more than double the computational resources required. Further, adding additional sensor components can decrease system reliability. Advantageously, techniques described herein for teacher/student training of deep neural networks can increase or enhance deep neural network performance in low-light or nonideal atmospheric conditions without increasing system complexity or requiring additional computing resources.

Teacher/student training of deep neural networks is implemented by training a first deep neural network, which may be referred to as the teacher neural network, using a training dataset that includes color or grayscale video and one or more of thermal IR and gated IR imaging along with ground truth for each type of included sensor. Once the first type of deep neural network is trained, a second deep neural network, which may be referred to as the student neural network, is trained using only video data and ground truth. The teacher neural network is operated in parallel while training the student neural network, using input sensor data that includes the same objects and ground truth as the student neural network. Both the teacher neural network and the student neural network output features indicating intermediate results to form portions of a loss function used to train the student neural network. In this fashion the student neural network can achieve the benefit of training on multiple types of sensor data while operating on video data using a light-weight neural network that consumes fewer computing resources than the teacher neural network.

A method is disclosed herein including, receiving an image in a first neural network that outputs a first prediction based on the image, wherein weights applied to layers in the first neural network are determined by minimizing a sum of a first loss function and a second loss function. The first loss function can be determined from first features determined in the first neural network trained to output a first prediction and from second features determined in a second neural network trained to output a second prediction. The second loss function can be determined based on comparing the first prediction to ground truth. The first prediction can be output. Determining weights can include backpropagating the sum of the first loss function and the second loss function to layers of the first neural network while varying the weights. The image received in the first neural network can be a video image, and the second neural network can receive a second video image and one or more of a thermal infrared image or a gated infrared image. The first neural network can include a first backbone that includes one or more convolutional layers and a first head that includes one or more fully connected layers.

The second neural network can include a second backbone that includes one or more convolutional layers and a second head that includes one or more fully connected layers. The first features can be output by the first backbone of the first neural network and the second features are output by the second backbone of the second neural network. A first location at which the first features are output by the first neural network and a second location at which the second features are output by the second neural network can be determined by comparing rates at which the of the sum of the first loss function and second loss function converges on a minimal value. Determining the first and second locations can include determining a rate at which the sum of the first loss function and the second loss function is minimized. The first loss function can be determined by determining a mean square error between the first features and the second features. The first loss function can be determined by a binary classifier that determines binary cross entropy between the first features and the second features. The trained second neural network can be output to a second computing system included in a vehicle. The trained second neural network can be used to operate the vehicle. The mean square error between the first features and the second features can be determined by the equation

$${ℒ}_{KD} = \frac{1}{NA} {\sum }_{i}^{N} {\sum }_{j}^{A} {( {F}_{i}^{S} ( j ) - {F}_{i}^{T} ( j ) )}^{2} .$$

The binary cross entropy between the first features and the second features can be determined by the equation

$${ℒ}_{BCE} = \frac{1}{N} {\sum }_{i}^{N} [ {t}_{i} ln {p}_{i} + ( 1 - {t}_{i} ) ln ( 1 - {p}_{i} ) ] .$$

Further disclosed is a computer readable medium, storing program instructions for executing some or all of the above method steps. Further disclosed is a computer programmed for executing some or all of the above method steps, including a computer apparatus, programmed to receive an image in a first neural network that outputs a first prediction based on the image, wherein weights applied to layers in the first neural network are determined by minimizing a sum of a first loss function and a second loss function. The first loss function can be determined from first features determined in the first neural network trained to output a first prediction and from second features determined in a second neural network trained to output a second prediction. The second loss function can be determined based on comparing the first prediction to ground truth. The first prediction can be output. Determining weights can include backpropagating the sum of the first loss function and the second loss function to layers of the first neural network while varying the weights. The image received in the first neural network can be a video image, and the second neural network can receive a second video image and one or more of a thermal infrared image or a gated infrared image. The first neural network can include a first backbone that includes one or more convolutional layers and a first head that includes one or more fully connected layers.

The instructions include further instructions wherein the second neural network can include a second backbone that includes one or more convolutional layers and a second head that includes one or more fully connected layers. The first features can be output by the first backbone of the first neural network and the second features are output by the second backbone of the second neural network. A first location at which the first features are output by the first neural network and a second location at which the second features are output by the second neural network can be determined by comparing rates at which the of the sum of the first loss function and second loss function converges on a minimal value. Determining the first and second locations can include determining a rate at which the sum of the first loss function and the second loss function is minimized. The first loss function can be determined by determining a mean square error between the first features and the second features. The first loss function can be determined by a binary classifier that determines binary cross entropy between the first features and the second features. The trained second neural network can be output to a second computing system included in a vehicle. The trained second neural network can be used to operate the vehicle. The mean square error between the first features and the second features can be determined by the equation

$${ℒ}_{KD} = \frac{1}{NA} {\sum }_{i}^{N} {\sum }_{j}^{A} {( {F}_{i}^{S} ( j ) - {F}_{i}^{T} ( j ) )}^{2} .$$

The binary cross entropy between the first features and the second features can be determined by the equation

$${ℒ}_{BCE} = \frac{1}{N} {\sum }_{i}^{N} [ {t}_{i} ln {p}_{i} + ( 1 - {t}_{i} ) ln ( 1 - {p}_{i} ) ] .$$

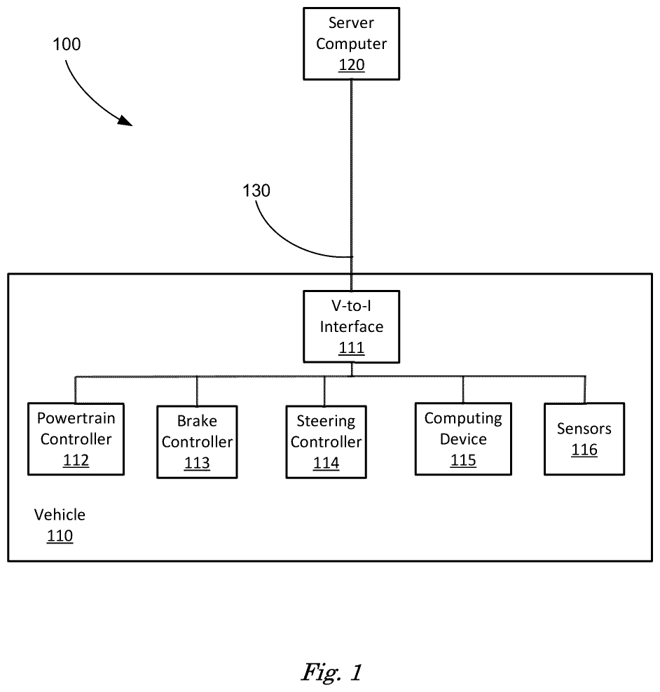

FIG. 1 is a diagram of a vehicle computing system 100. Vehicle computing system 100 includes a vehicle 110, a computing device 115 included in the vehicle 110, and a server computer 120 remote from the vehicle 110. One or more vehicle 110 computing devices 115 can receive data regarding the operation of the vehicle 110 from sensors 116. The computing device 115 may operate the vehicle 110 based on data received from the sensors 116 and/or data received from the remote server computer 120. The server computer 120 can communicate with the vehicle 110 via a network 130.

The computing device 115 includes a processor and a memory such as are known. Further, the memory includes one or more forms of computer-readable media, and stores instructions executable by the processor for performing various operations, including as disclosed herein. For example, the computing device 115 may include programming to operate one or more of vehicle brakes, propulsion (i.e., control of acceleration in the vehicle 110 by controlling one or more of an internal combustion engine, electric motor, hybrid engine, etc.), steering, climate control, interior and/or exterior lights, etc., as well as to determine whether and when the computing device 115, as opposed to a human operator, is to control such operations.

The computing device 115 may include or be communicatively coupled to, i.e., via a vehicle communications bus as described further below, more than one computing devices, i.e., controllers or the like included in the vehicle 110 for monitoring and/or controlling various vehicle components, i.e., a propulsion controller 112, a brake controller 113, a steering controller 114, etc. The computing device 115 is generally arranged for communications on a vehicle communication network, i.e., including a bus in the vehicle 110 such as a controller area network (CAN) or the like; the vehicle 110 network can additionally or alternatively include wired or wireless communication mechanisms such as are known, i.e., Ethernet or other communication protocols.

Via the vehicle network, the computing device 115 may transmit messages to various devices in the vehicle and/or receive messages from the various devices, i.e., controllers, actuators, sensors, etc., including sensors 116. Alternatively, or additionally, in cases where the computing device 115 actually comprises multiple devices, the vehicle communication network may be used for communications between devices represented as the computing device 115 in this disclosure. Further, as mentioned below, various controllers or sensing elements such as sensors 116 may provide data to the computing device 115 via the vehicle communication network.

In addition, the computing device 115 may be configured for communicating through a vehicle-to-infrastructure (V2X) interface 111 with a remote server computer 120, i.e., a cloud server, via a network 130, which, as described below, includes hardware, firmware, and software that permits computing device 115 to communicate with a remote server computer 120 via a network 130 such as wireless Internet (WI-FI®) or cellular networks. V2X interface 111 may accordingly include processors, memory, transceivers, etc., configured to utilize various wired and/or wireless networking technologies, i.e., cellular, BLUETOOTH®, Bluetooth Low Energy (BLE), Ultra-Wideband (UWB), Peer-to-Peer communication, UWB based Radar, IEEE 802.11, and/or other wired and/or wireless packet networks or technologies. Computing device 115 may be configured for communicating with other vehicles 110 through V2X (vehicle-to-everything) interface 111 using vehicle-to-vehicle (V-to-V) networks, i.e., according to including cellular communications (C-V2X) wireless communications cellular, Dedicated Short Range Communications (DSRC) and/or the like, i.e., formed on an ad hoc basis among nearby vehicles 110 or formed through infrastructure-based networks. The computing device 115 also includes nonvolatile memory such as is known. Computing device 115 can log data by storing the data in nonvolatile memory for later retrieval and transmittal via the vehicle communication network and a vehicle to infrastructure (V2X) interface 111 to a server computer 120 or user mobile device 160.

As already mentioned, generally included in instructions stored in the memory and executable by the processor of the computing device 115 is programming for operating one or more vehicle 110 components, i.e., braking, steering, propulsion, etc., without intervention of a human operator. Using data received in the computing device 115, i.e., the sensor data from the sensors 116, the server computer 120, etc., the computing device 115 may make various determinations and/or control various vehicle 110 components and/or operations. For example, the computing device 115 may include programming to regulate vehicle 110 operational behaviors (i.e., physical manifestations of vehicle 110 operation) such as speed, acceleration, deceleration, steering, etc., as well as tactical behaviors (i.e., control of operational behaviors typically in a manner intended to achieve efficient traversal of a route) such as a distance between vehicles and/or amount of time between vehicles, lane-change, minimum gap between vehicles, left-turn-across-path minimum, time-to-arrival at a particular location and intersection (without signal) minimum time-to-arrival to cross the intersection.

Controllers, as that term is used herein, include computing devices that typically are programmed to monitor and/or control a specific vehicle subsystem. Examples include a propulsion controller 112, a brake controller 113, and a steering controller 114. A controller may be an electronic control unit (ECU) such as is known, possibly including additional programming as described herein. The controllers may communicatively be connected to and receive instructions from the computing device 115 to actuate the subsystem according to the instructions. For example, the brake controller 113 may receive instructions from the computing device 115 to operate the brakes of the vehicle 110.

The one or more controllers 112, 113, 114 for the vehicle 110 may include known electronic control units (ECUs) or the like including, as non-limiting examples, one or more propulsion controllers 112, one or more brake controllers 113, and one or more steering controllers 114. Each of the controllers 112, 113, 114 may include respective processors and memories and one or more actuators. The controllers 112, 113, 114 may be programmed and connected to a vehicle 110 communications bus, such as a controller area network (CAN) bus or local interconnect network (LIN) bus, to receive instructions from the computing device 115 and control actuators based on the instructions.

Sensors 116 may include a variety of devices known to provide data via the vehicle communications bus. For example, a radar fixed to a front bumper (not shown) of the vehicle 110 may provide a distance from the vehicle 110 to a next vehicle in front of the vehicle 110, or a global positioning system (GPS) sensor disposed in the vehicle 110 may provide geographical coordinates of the vehicle 110. The distance(s) provided by the radar and/or other sensors 116 and/or the geographical coordinates provided by the GPS sensor may be used by the computing device 115 to operate the vehicle 110 autonomously or semi-autonomously, for example.

The vehicle 110 is generally a land-based vehicle 110 capable of autonomous and/or semi-autonomous operation and having three or more wheels, i.e., a passenger car, light truck, etc. The vehicle 110 includes one or more sensors 116, the V2X interface 111, the computing device 115 and one or more controllers 112, 113, 114. The sensors 116 may collect data related to the vehicle 110 and the environment in which the vehicle 110 is operating. By way of example, and not limitation, sensors 116 may include, i.e., altimeters, cameras, LIDAR, radar, ultrasonic sensors, infrared sensors, pressure sensors, accelerometers, gyroscopes, temperature sensors, pressure sensors, hall sensors, optical sensors, voltage sensors, current sensors, mechanical sensors such as switches, etc. The sensors 116 may be used to sense the environment in which the vehicle 110 is operating, i.e., sensors 116 can detect phenomena such as weather conditions (precipitation, external ambient temperature, etc.), the grade of a road, the location of a road (i.e., using road edges, lane markings, etc.), or locations of target objects such as neighboring vehicles 110. The sensors 116 may further be used to collect data including dynamic vehicle 110 data related to operations of the vehicle 110 such as velocity, yaw rate, steering angle, engine speed, brake pressure, oil pressure, the power level applied to controllers 112, 113, 114 in the vehicle 110, connectivity between components, and accurate and timely performance of components of the vehicle 110.

Server computer 120 typically has features in common, e.g., a computer processor and memory and configuration for communication via a network 130, with the vehicle 110 V2X interface 111 and computing device 115, and therefore these features will not be described further to reduce redundancy. A server computer 120 can be used to develop and train software that can be transmitted to a computing device 115 in a vehicle 110.

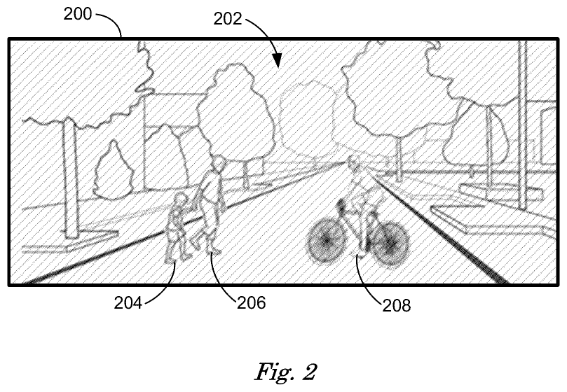

FIG. 2 is a diagram of an image 200 of scene 202. Scene 202 was acquired by a video camera in nonideal atmospheric conditions. Scene 202 includes pedestrians 204, 206 and a bicyclist 208. As discussed above, video image 200 can be difficult to process using a deep neural network. Acquiring additional images of scene 202 with thermal IR or gated IR can provide additional contrast for pedestrians 204, 206 and bicyclist 208. Additional contrast can make detecting pedestrians 204, 206 and bicyclist 208 more reliable for a deep neural network while consuming greater computing resources.

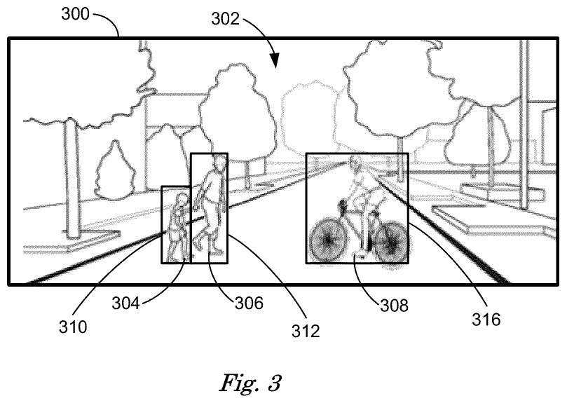

FIG. 3 is a diagram of an image 300 of a scene 302. Scene 302 was acquired by a gated IR sensor in nonideal atmospheric conditions. Scene 302 includes pedestrians 304, 306 and a bicyclist 308. Acquiring image 300 of a scene 302 in nonideal atmospheric conditions with a gated IR sensor can provide greater contrast for objects in the scene 302, including pedestrians 304, 306 and bicyclist 308. A trained deep neural network was able to process image 300 to detect pedestrians 304, 306 and bicyclist 308 despite nonideal atmospheric conditions indicated by bounding boxes 310, 312, 314 around pedestrians 304, 306 and bicyclist 308, respectively.

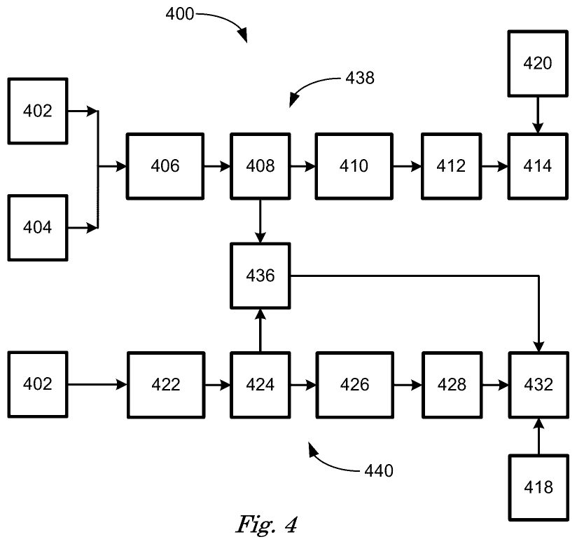

FIG. 4 is a diagram of a teacher/student deep neural network training system 400. Teacher/student deep neural network training system 400 uses knowledge distillation (KD) 436. Knowledge distillation refers to transferring training data from a large model to a smaller model. Techniques described herein share training knowledge from a teacher deep neural network 438 to a student deep neural network 440. The teacher deep neural network 438 includes various layers that for convenience can be described as variously grouped into a backbone 406, teacher features 408, and a head 410. The backbone 406 includes convolutional layers that receive video images 402 and gated IR images 404 and generate teacher features 408. Teacher deep neural network 438 can also receive other types of input data, for example thermal IR images, lidar images, radar images etc., in addition to video images 402 and gated IR images 404. Teacher features 408 encode object data while suppressing irrelevant data in the input images 402, and gated IR images 404. Irrelevant data can be suppressed by convolutional filters in the backbone 406. Head 410 includes fully connected layers that decode the teacher features 408 into a prediction 412 that can include object location and identification data.

Teacher deep neural network 438 is trained by receiving video images 402 and gated IR images 404 and producing predictions 412. Video images 402 and gated IR images 404 can be paired, meaning that the training dataset includes pairs of video images 402 and gated IR images 404 that include the same fields of view at the same resolution acquired at substantially the same time, e.g., under same atmospheric and lighting conditions. Paired video images 402 and gated IR images 404 include the same objects at the same locations and have the same associated ground truth data. Paired video image 402 and gated IR images 404 can be “stacked” when received by the teacher deep neural network 438. Stacking refers to generating an image with a pixel bit depth formed by concatenating the pixels from a first image with pixels from a second image. Each pixel location in the image processed by the teacher deep neural network 438 includes bits from both video image 402 pixels and gated IR image 404 pixels.

A combined video image 402 and gated IR image 404 is processed by the convolutional layers of the backbone 406 and the fully connected layers of the head 410 to produce an object identification and location prediction 412. The prediction 412 are combined with ground truth 420 regarding the input images 402, and gated IR images 404 to produce a loss function 414 that indicates how closely a prediction 412 matches the ground truth, e.g., whether the prediction 412 indicates a correct object at the correct location as indicated by the ground truth 420. The loss function 414 is back-propagated through the layer of the head 410 and the backbone 406 from back to front, selecting the weights that provide a minimal loss for the input images 402, and gated IR images 404 included in a training dataset.

Once the teacher deep neural network 438 is trained, the student deep neural network 440 can be trained. The student deep neural network is 440 trained in similar fashion to the teacher deep neural network 438, except the input to the student deep neural network is 440 is solely video images 402, and the loss function can be determined by both a ground truth 418 based loss function 432 and a KD 436 based loss function. Ground truth 418 for student deep neural network 440 is the same as ground truth 420 for teacher deep neural network 438, except that student deep neural network 440 ground truth 418 only includes video image 402 ground truth. Student deep neural network 440 includes a backbone 422 which includes convolutional layers and outputs student features 424. Student features 424 encode object data included in input video images 402 while suppressing irrelevant data in the input images 402. Head 426 includes fully connected layers that decode the student features 424 into a prediction 428 that can include object location and identification data.

When a video image 402 is received by the backbone 422 of the student deep neural network 440, the same video image 402 or a gated IR image 404, that includes the same object data and includes the same ground truth 420, is received by the backbone 406 of the teacher deep neural network 438. In response to receiving the video images 402, the student deep neural network 440 and the teacher deep neural network 438 generate teacher features 408 and student features 424, respectively, that are combined by KD 436 to determine a KD loss function L_{KD}. The layer of the backbone 406 at which the teacher features 408 are emitted and the layer of the backbone 422 at which student features 424 are emitted can be adjusted depending upon a rate at which the KD loss function [symbol] converges on a minimal value.

KD 436 combines the student features 424 from the student deep neural network 440 and the teacher features 408 from the teacher deep neural network 438 to form a KD loss function [symbol] that measures the mean square error between student features 424 and teacher features 408 according to the equation:

$${ℒ}_{KD} = \frac{1}{NA} {\sum }_{i}^{N} {\sum }_{j}^{A} {( {F}_{i}^{S} ( j ) - {F}_{i}^{T} ( j ) )}^{2} \qquad ( 1 )$$

Where Fᵢ^{S} and Fᵢ^{T} are student features 424 and teacher features 408, respectively, of the i-th input image 402, 404 in the training dataset for student deep neural network 440 and teacher deep neural network 438, respectively, N is the number of images in the training dataset, and A is the total number of student and teacher features 408, 424. The KD loss function [symbol] is combined with the ground truth loss function [symbol] 432 to form a sum equal to an overall loss function [symbol] by the equation:

$$ℒ = {ℒ}_{GT} + {αℒ}_{KD} \qquad ( 2 )$$

Where α is a user determined weight parameter that balances a trade-off between ground truth detection loss ( [symbol] ) and KD loss ( [symbol] _KD). The weight parameter α determines the amount of knowledge distillation in training the student deep neural network 440. The overall loss function [symbol] is applied to the layers of the head 428 and backbone 422 by back propagating the overall loss function [symbol] through the layers from output layers to input layers to minimize the overall loss function [symbol] by modifying the weights used to program the head 428 and backbone 422.

Following training, the student deep neural network 440 can be transmitted to a computing device 115 in a vehicle 110. Because student deep neural network 440 was trained, in part, using a loss function based on a KD loss function determined by a teacher deep neural network 438 that receives both video images 402 and gated IR images 404, the student deep neural network 440 can determine the same output predictions 428 as the teacher deep neural network 438 despite not being trained using gated IR images 404. The student deep neural network 440 can determine output predictions 428 based on receiving video images 402 acquired by video sensors included in vehicle 110. Because student deep neural network 440 processes only video images 402, determining predictions 428 requires fewer computing resources than a teacher deep neural network 438 requires in determining similar predictions 412.

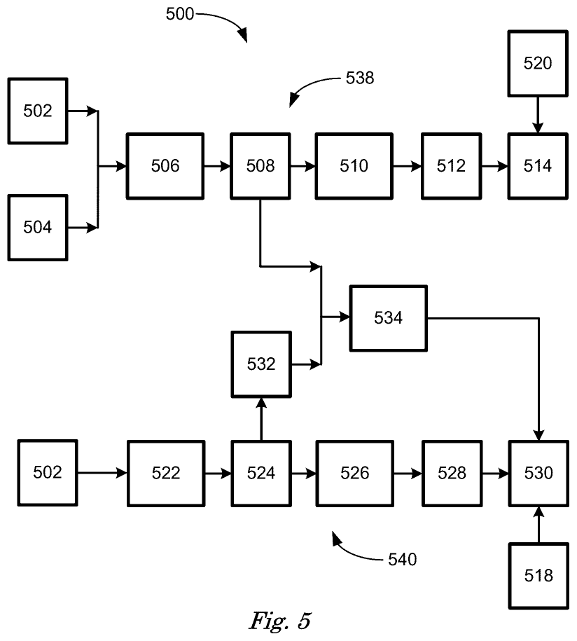

FIG. 5 is a diagram of another teacher/student deep neural network training system 500. Teacher/student deep neural network training system 500 uses adversarial training 534 to share training knowledge from the teacher deep neural network 538 to the student deep neural network 540. The teacher deep neural network 538 includes a backbone 506, teacher features 508, and a head 510. The backbone 506 includes convolutional layers that receive video images 502 and gated IR images 504 and generate teacher features 508. Teacher deep neural network 538 can also receive other types of input data, for example thermal IR images, etc., in addition to video images 502 and gated IR images 504. Teacher features 508 encode object data while suppressing irrelevant data in the input video images 502, and gated IR images 504. Head 510 includes fully connected layers that decode the teacher features 508 into a prediction 512 that can include object location and identification data.

Teacher deep neural network 538 is trained as discussed above in relation to FIG. 4, by receiving video images 502 and gated IR images 504 and producing predictions 512. As described above in relation to FIG. 4, video images 502 and gated IR images 504 can be paired, meaning that the training dataset includes pairs of video images 502 and gated IR images 504 that include the same fields of view at the same resolution acquired at substantially the same time, e.g., under the same atmospheric and lighting conditions. Paired video images 502 and gated IR images 504 include the same objects at the same locations and have the same associated ground truth data. Paired video image 502 and gated IR images 504 can be “stacked” when received by the teacher deep neural network 538, meaning that each pixel location in the image processed by the teacher deep neural network 538 includes bits from both video image 502 pixels and gated IR image 504 pixels.

A combined video image 502 and gated IR image 504 is processed by the backbone 506 and the head 510 to output an object identification and location prediction 512. The prediction 512 are combined with ground truth 520 regarding the input images 502, 504 to generate a loss function 514 that indicates how closely a prediction 512 matches the ground truth 520, e.g., whether the prediction 512 indicates a correct object at the correct location as indicated by the ground truth 520. The loss function 514 can be back-propagated through the layer of the head 510 and the backbone 506 from back to front, selecting the weights that provide a minimal loss when repeated for the video images 502 and gated IR images 504 included in a training dataset.

Once the teacher deep neural network 538 is trained, the student deep neural network 540 can be trained. The student deep neural network 540 can be trained in similar fashion to the teacher deep neural network 538, except the input to the student deep neural network 540 is solely video images 502, and the loss function can be determined by both a ground truth 518 based loss function 530 and adversarial network 454 based loss function. Ground truth 518 for student deep neural network 540 is the same as ground truth 520 for teacher deep neural network 538 except student deep neural network 540 ground truth 518 only includes video image 502 ground truth. Student deep neural network 540 includes a backbone 522 which includes convolutional layers and outputs student features 524. Student features 524 encode object data included in input video images 502 while suppressing irrelevant data in the input images 502. Head 526 includes fully connected layers that decode the student features 524 into a prediction 528 that can include object location and identification data.

When a video image 502 is received by the backbone 522 of the student deep neural network 540, the same video image 502 or a gated IR image 404 that includes the same object data and includes the same ground truth 520 as the ground truth 518 is input to the backbone 506 of the teacher deep neural network 538. In response to receiving the images 502 the student deep neural network 540 generates student features 524 which are combined by adversarial network 534 to determine an adversarial loss function 536.

Adversarial network 534 is a binary classifier network (BCN) that classifies the teacher features 508 and student features 525 as 1's and 0's. Adversarial network 534 includes two convolutional layers to reduce the student feature 524 and teacher feature 508 channels to a single channel, followed by two fully connected layers to predict a final binary class probability, i.e., 0 for student and 1 for teacher). During training, the extracted student features 524 and teacher features 508 from the backbones 506, 522 of both teacher deep neural network 538 and student deep neural network 5540 to the adversarial network 534. The layer of the backbone 506 at which the teacher features 508 are emitted and the layer of the backbone 522 at which student features 524 are emitted can be adjusted depending upon a rate at which the binary cross entropy loss function L_{BCE} converges on a minimal value.

Adversarial network 534 is trained to differentiate between teacher features 508 and student features 524 by minimizing binary cross entropy loss. Binary cross entropy loss means a loss function that determines whether features input to the adversarial network 534 are teacher features 508 or student features 524. The objective is to train the student deep neural network 540 to generate student features 524 that are accepted by the adversarial network 534 as teacher features 524. Binary cross entropy uses logarithmic functions to penalize incorrect classifications and generate a two-valued result, e.g., “0” for student features 524 and “1” for teacher features 508. To increase the ability of the adversarial network 534 to generate student features 524 that are similar to teacher features 508, the student features 524 are processed by a gradient reversal 532, which reverses the direction in which the student features 524 classified by adversarial training as student features 524 increase or decrease in response to changes in backbone 522 weights. Performing gradient reversal on the student features 524 can enhance training of the student deep neural network 540 to output student features 524 that are accepted by adversarial network 534 as teacher features 508.

Adversarial network 534 generates a binary cross entropy loss function [symbol] . Binary cross entropy loss function [symbol] can be determined by the equation:

$${ℒ}_{BCE} = \frac{1}{N} {\sum }_{i}^{N} [ {t}_{i} ln {p}_{i} + ( 1 - {t}_{i} ) ln ( 1 - {p}_{i} ) ] \qquad ( 3 )$$

Where tᵢ is the ground truth 520, 518 label of the binary classifier for the i-th input video image 502 in the training dataset, with tᵢ=1 for teacher features 508 and tᵢ=0 for student features 524. pᵢ is the probability of binary cross entropy for student features 508 and teacher features 524 for the i-th input video image 502 in the training dataset and N is the number of video images 502 in the training dataset. The adversarial loss function [symbol] is combined with the ground truth loss function [symbol] 530 to form a sum equal to an overall loss function [symbol] by the equation:

$$ℒ = {ℒ}_{GT} + {λℒ}_{BCE} \qquad ( 4 )$$

Where λ is a user determined weight parameter that balances a trade-off between ground truth detection loss ( [symbol] ) and adversarial loss ( [symbol] _BCE). The weight parameter/determines the amount of knowledge distillation in training the student deep neural network 540. The overall loss function [symbol] is applied to the layers of the head 526 and backbone 522 by back-propagating the overall loss function [symbol] through the layers from output layers to input layers to minimize the overall loss function [symbol] by modifying the weights used to program the head 526 and backbone 522.

Following training, the student deep neural network 540 can be transmitted to a computing device 115 in a vehicle 110. Because student deep neural network 540 was trained, in part, using a loss function based on an adversarial loss function determined by a teacher deep neural network 538 that receives both video images 502 and gated IR images 504, the student deep neural network 540 can determine the same output predictions 528 as the teacher deep neural network 538 despite not being trained using gated IR images 504. The student deep neural network 540 can determine output predictions 528 based on receiving video images 502 acquired by video sensors included in vehicle 110. Because student deep neural network 540 processes only video images 502, determining predictions 528 requires fewer computing resources than a teacher deep neural network 538 requires in determining similar predictions 512.

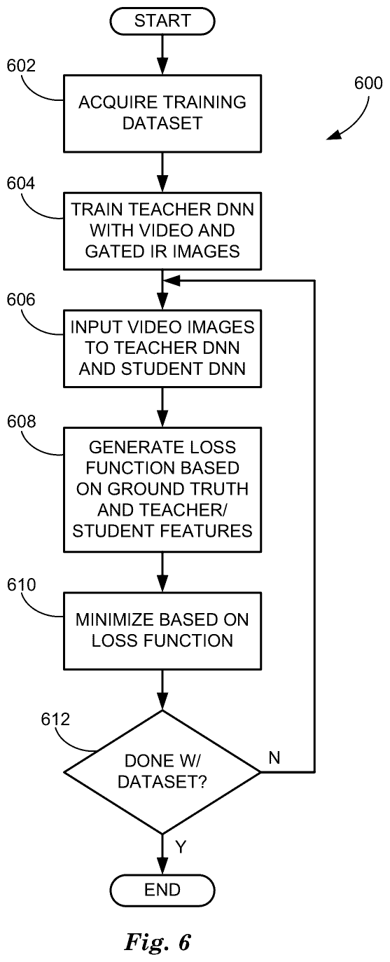

FIG. 6 is a flowchart of a process 600 for training a student deep neural network 440, 540 using a teacher deep neural network 438, 538. Process 600 can be implemented in a server computer 120, for example. Process 600 includes multiple blocks that can be executed in the illustrated order. Process 600 could alternatively or additionally include fewer blocks or can include the blocks executed in different orders.

Process 600 begins at block 602, where a training dataset of video images 402, 502 and images acquired with one or more other types of sensors is acquired. The one or more other types of images can include gated IR images 404, 504 or thermal IR sensors, for example. The training dataset includes ground truth data which includes identities and locations of objects included in the training dataset images 402, 502, 404, 504.

At block 604 the teacher deep neural network 438, 538 is trained using the training dataset of images 402, 502, 404, 504 as described in relation to FIGS. 4 and 5, above.

At block 606, the student deep neural network 440, 538 training begins. As described above in relation to FIGS. 4 and 5, when a video image 402, 502 is received by the student deep neural network 440, 538, a video image 402, 502 combined with a gated IR image 404, 504 is received by the trained teacher deep neural network.

At block 608, student features 424, 524 output by student deep neural network 440, 540 in response to receiving a video image 402, 502 are combined with teacher features 408, 508 output by teacher deep neural network 438, 538 in response to receiving a video image 402, 502 combined with a gated IR image 404, 504. In an example of student/teacher training as described in relation to FIG. 4, the student features 424 are combined with teacher features 408 using KD 436 which determines knowledge distillation loss function which is combined with a ground truth loss function to determine an overall loss function [symbol] . In another example of student/teacher training as described in relation to FIG. 5, the student features 524 are combined with teacher features 508 using an adversarial network 536 which determines binary cross entropy loss function which is combined with a ground truth loss function to determine an overall loss function [symbol] .

At block 610 the overall loss function [symbol] is back propagated through the student deep neural network 440, 540 to determine the weights which will minimize the loss function [symbol] as discussed above in relation to FIGS. 4 and 5.

At block 612 the training loop determines whether the loss function [symbol] converges to a minimal value and all the images 402, 502, 404, 504 have been received by the student deep neural network 440, 540. If the images are not complete or the loss function [symbol] has not converged, process 600 loops back to process more images. If the images 402, 502, 404, 504 are complete and loss function [symbol] has converged on a minimal value, process 600 ends.

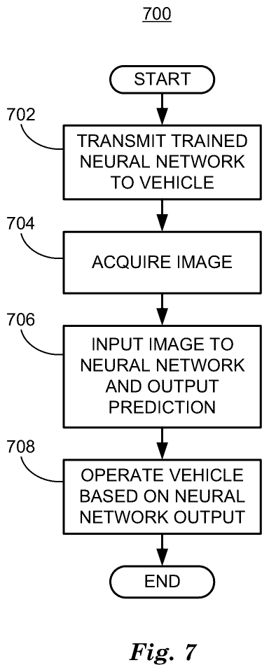

FIG. 7 is a flowchart of a process 700 for operating a vehicle 110 based on student neural network 440, 540. Process 700 is described in terms of operating a vehicle as a non-limiting example. Process 700 can be applied more generally to moving systems. For example, process 700 can provide high-resolution pose data to mobile systems such as mobile robots and drones. Process 700 can also be applied to systems that include moving components, such as stationary robots, package sorting systems, and security systems. Process 700 can be implemented by computing device 115 included in vehicle 110. Process 700 includes multiple blocks that can be executed in the illustrated order. Process 700 could alternatively or additionally include fewer blocks or can include the blocks executed in different orders.

Process 700 begins at block 702, where a computing device 115 in a vehicle 110 receives a student deep neural network 440, 540, trained using a teacher deep neural network 438, 538. Student deep neural network 440, 540 can be trained on a server computer 120, for example, and transmitted to a computing device 115 included in a vehicle 110.

At block 704 computing device 115 acquires a video image 402, 502 from a video sensor included in a vehicle 110.

At block 706 student deep neural network 440, 540, executing on computing device 115 in vehicle 110 receives the video image 402, 502, processes it and outputs a prediction which can include an identity and location of an object included in the video image 402, 502. The object can be a pedestrian, bicyclist, vehicle, or other object that can be located on a roadway.

At block 708 computing device 115 operates vehicle 110 based on the object identity and location prediction output by student deep neural network 440, 540. For example, computing device 115 can determine a path polynomial that directs vehicle motion from a current location based on the object identity and location. Vehicle 110 can be operated by determining a path polynomial function which maintains minimum and maximum limits on lateral and longitudinal accelerations, for example. Vehicle 110 can be operated along a path polynomial by transmitting commands to controllers 112, 113, 114 to control vehicle propulsion, steering and brakes. Following block 708 process 700 ends.

Computing devices such as those described herein generally each includes commands executable by one or more computing devices such as those identified above, and for carrying out blocks or steps of processes described above. For example, process blocks described above may be embodied as computer-executable commands.

Computer-executable commands may be compiled or interpreted from computer programs created using a variety of programming languages and/or technologies, including, without limitation, and either alone or in combination, Java™, C, C++, Python, Julia, SCALA, Visual Basic, Java Script, Perl, HTML, etc. In general, a processor (i.e., a microprocessor) receives commands, i.e., from a memory, a computer-readable medium, etc., and executes these commands, thereby performing one or more processes, including one or more of the processes described herein. Such commands and other data may be stored in files and transmitted using a variety of computer-readable media. A file in a computing device is generally a collection of data stored on a computer readable medium, such as a storage medium, a random access memory, etc.

A computer-readable medium (also referred to as a processor-readable medium) includes any non-transitory (i.e., tangible) medium that participates in providing data (i.e., instructions) that may be read by a computer (i.e., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

The term “exemplary” is used herein in the sense of signifying an example, i.e., a candidate to an “exemplary widget” should be read as simply referring to an example of a widget.

The adverb “approximately” modifying a value or result means that a shape, structure, measurement, value, determination, calculation, etc. may deviate from an exactly described geometry, distance, measurement, value, determination, calculation, etc., because of imperfections in materials, machining, manufacturing, sensor measurements, computations, processing time, communications time, etc.

In the drawings, the same reference numbers indicate the same elements. With regard to the media, processes, systems, methods, etc. described herein, it should be understood that, although the steps or blocks of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

1. A system, comprising:
a computer that includes a processor and a memory, the memory including instructions executable by the processor to:
receive an image in a first neural network that outputs a first prediction based on the image, wherein weights applied to layers in the first neural network are determined by minimizing a sum of a first loss function and a second loss function;
wherein the first loss function is determined from first features determined in the first neural network trained to output a first prediction and from second features determined in a second neural network trained to output a second prediction;
wherein the second loss function is determined based on comparing the first prediction to ground truth; and
output the first prediction.

2. The system of claim 1, wherein determining weights includes backpropagating the sum of the first loss function and the second loss function to layers of the first neural network while varying the weights.

3. The system of claim 1, wherein the image received in the first neural network is a video image, and the second neural network receives a second video image and one or more of a thermal infrared image or a gated infrared image.

4. The system of claim 1, wherein the first neural network includes a first backbone that includes one or more convolutional layers and a first head that includes one or more fully connected layers.

5. The system of claim 4, wherein the second neural network includes a second backbone that includes one or more convolutional layers and a second head that includes one or more fully connected layers.

6. The system of claim 5, wherein the first features are output by the first backbone of the first neural network and the second features are output by the second backbone of the second neural network.

7. The system of claim 1, wherein a first location at which the first features are output by the first neural network and a second location at which the second features are output by the second neural network are determined by comparing rates at which the of the sum of the first loss function and second loss function converges on a minimal value.

8. The system of claim 7, wherein determining the first and second locations includes determining a rate at which the sum of the first loss function and the second loss function is minimized.

9. The system of claim 1, wherein the first loss function is determined by determining a mean square error between the first features and the second features.

10. The system of claim 1, wherein the first loss function is determined by a binary classifier that determines binary cross entropy between the first features and the second features.

11. The system of claim 1, wherein the trained second neural network is output to a second computing system included in a vehicle.

12. The second computing system of claim 11, wherein the trained second neural network is used to operate the vehicle.

13. A method, comprising:
receiving an image in a first neural network that outputs a first prediction based on the image, wherein weights applied to layers in the first neural network are determined by minimizing a sum of a first loss function and a second loss function;
wherein the first loss function is determined from first features determined in the first neural network trained to output a first prediction and from second features determined in a second neural network trained to output a second prediction;
wherein the second loss function is determined based on comparing the first prediction to ground truth; and
outputting the first prediction.

14. The method of claim 13, wherein determining weights includes backpropagating the sum of the first loss function and the second loss function to layers of the first neural network while varying the weights.

15. The method of claim 13, wherein the image received in the first neural network is a video image, and the second neural network receives a second video image and one or more of a thermal infrared image or a gated infrared image.

16. The method of claim 13, wherein the first neural network includes a first backbone that includes one or more convolutional layers and a first head that includes one or more fully connected layers.

17. The method of claim 16, wherein the second neural network includes a second backbone that includes one or more convolutional layers and a second head that includes one or more fully connected layers.

18. The method of claim 17, wherein the first features are output by the first backbone of the first neural network and the second features are output by the second backbone of the second neural network.

19. The method of claim 13, wherein a first location at which the first features are output by the first neural network and a second location at which the second features are output by the second neural network are determined by comparing rates at which the of the sum of the first loss function and second loss function converges on a minimal value.

20. The method of claim 19, wherein determining the first and second locations includes determining a rate at which the sum of the first loss function and the second loss function is minimized.
